(19) United States
(12) Patent Application Publication
(10) Pub. No.: US 2023/0147930 A1
(43) Pub. Date: May 11, 2023

(54) MANUFACTURING SYSTEM FOR ADDITIVE PRODUCTION OF COMPONENTS, AND METHOD

(71) Applicant: AEDITIVE GMBH, Norderstedt (DE)

(72) Inventors: Hendrik LINDEMANN, Hamburg (DE); Roman GERBERS, Hamburg (DE); Niklas NOLTE, Hamburg (DE); Alexander TÜRK, Hamburg (DE)

(21) Appl. No.: 17/918,004

(22) PCT Filed: Apr. 12, 2021
(86) PCT No.: PCT/DE2021/100327

§ 371 Date: Oct. 10, 2022

(30) Foreign Application Priority Data
Apr. 16, 2020 (DE) 10 2020 110 431.6

(51) Int. Cl. B28B 1/00; B33Y 10/00; B33Y 30/00; B28B 15/00

(52) U.S. Cl. CPC B28B 1/001; B33Y 10/00; B33Y 30/00; B28B 15/00

(57) ABSTRACT

The invention relates to a manufacturing system (1) for additively producing concrete components, in particular for carrying out a spraying process for additively producing concrete components, a method for additively producing a concrete component, in particular using a shotcrete process, and a method for setting up a manufacturing system (1). In particular, the invention relates to a manufacturing system (1) for the additive production of structural components, preferably concrete structural components, in particular for carrying out a spraying process, preferably a shotcrete process, for the additive production of structural components, preferably concrete structural components, comprising a first manufacturing module (100) having a mixing unit (106) for producing a composite material, preferably a concrete, in particular by mixing a first material component, preferably a first concrete component, and a second material component, preferably a second concrete component, and a second manufacturing module (200) with a first handling unit (212) for additive production of a component with the composite material, in particular for production of a sprayed component, preferably a shotcrete component, wherein the first manufacturing module (100) and the second manufacturing module (200) are coupled by means of a conveyor unit (112).

The invention relates to a manufacturing system for the additive manufacturing of components, in particular for carrying out a spraying process for the additive manufacturing of components, a process for the additive manufacturing of a component, in particular using a spraying process, and a process for setting up a manufacturing system.

Manufacturing systems are known in principle. They may, for example, comprise different processing machines and handling systems in order to manufacture components, in particular in series production. The disadvantage of known manufacturing systems is their low flexibility.

Today's manufacturing systems for the additive manufacturing of components, especially concrete components, require a high level of manual input, for which specially trained skilled workers are needed. Since many countries already have or are facing a shortage of skilled workers, especially in the construction industry, there is a need to automate the process for manufacturing building components. In addition, there may be quality deficiencies in the components, as human errors can reduce quality.

In addition, the known manufacturing systems for the production of components, especially for the additive manufacturing of concrete components, are inflexible. Usually, these manufacturing systems are embedded in an existing factory structure. As the demands on a manufacturing system change in shorter and shorter cycles, it is a need in the construction industry, for example, to use a flexible manufacturing system. In addition, it may be preferred that this flexibility also provides the ability to manufacture concrete components on or near a construction site. However, current manufacturing systems cannot be moved to a construction site, so concrete components are manufactured in the manufacturing system embedded in the factory and subsequently transported from the manufacturing system toward the construction site.

Additive manufacturing of structural components regularly involves the mixing of two or more material components, and this mixing is often provided as a material component mix. Material component mixes can be provided for concrete components or ceramic components, for example. Currently, for example, concrete components produced by an additive manufacturing process are typically produced using a factory dry premixed concrete component mix. The concrete component mix is made available to a component manufacturer using an additive manufacturing process, but the latter can only exert limited or no influence on the composition of the concrete component mix.

It is therefore an object of the present invention to provide a manufacturing system for the additive manufacturing of components, in particular for carrying out a spraying process for the additive manufacturing of components, a process for the additive manufacturing of a component, in particular using a spraying process, and a process for setting up a manufacturing system, which reduce or eliminate one or more of the said disadvantages. In particular, it is an object of the invention to provide a solution that enables automated production of individual concrete components. At least, it is an object of the invention to provide an alternative manufacturing system and method.

According to a first aspect, the aforementioned task is solved by a manufacturing system for the additive production of components, preferably concrete components, in particular for carrying out a spraying process, preferably a shotcrete process, for the additive production of components, preferably concrete components, comprising a first manufacturing module with a mixing unit for producing a composite material, preferably a concrete, in particular by mixing a first material component, preferably a first concrete component, and a second material component, preferably a second concrete component, and a second manufacturing module comprising a first handling unit for additive production of a component with the composite material, preferably a concrete component with the concrete, in particular for production of a sprayed component, preferably a shotcrete component, wherein the first manufacturing module and the second manufacturing module are coupled by means of a conveyor unit.

The invention is based on the perception that existing manufacturing systems for additive manufacturing of components, in particular concrete components, are inflexible. Furthermore, multi-part manufacturing systems have not been successful in the past because the interfaces between the multiple parts of these manufacturing systems have led to quality losses and productivity losses. The invention was now based on the finding that the two manufacturing modules, one manufacturing module comprising the mixing unit and the other manufacturing module comprising the handling unit for additive manufacturing of the component, in particular the concrete component, provide a division that such interface problems essentially do not occur. It has also been found that such a partitioning enables components, in particular concrete components, to be produced, in particular using a shotcrete process, which are technically superior to such components produced conventionally.

The first manufacturing module with the mixing unit enables the composite material to be provided. The mixing unit can also have load cells, in particular be mounted on load cells, so that weighing of the material components is made possible by means of the mixing unit. A composite material is understood to mean, in particular, a material that has at least two material components. The composite material is produced in particular by mixing the first material component with the second material component. The composite material can be concrete, for example. In the following, the manufacturing system and methods are described in particular in connection with the production and processing of concrete. However, the following is to be understood in an analogous manner for the generation and processing of other composite materials.

The mixing unit is designed in particular for producing a concrete with a hydraulic binder, an alkali-activated binder and/or a geopolymer binder. By concrete is to be understood in particular the still young, workable concrete. The concrete is produced in particular by mixing the first concrete component and the second concrete component with one another. The concrete component may or may not be, for example, an aggregate, a mixing water, concrete admixtures and/or a hydraulic binder such as cement and/or an alkali-activated binder and/or a geopolymer binder and/or concrete admixtures. The concrete admixtures may be solid or liquid, for example.

The second manufacturing module comprises the first handling unit. The first handling unit is arranged and configured to additively manufacture a structural component, preferably a concrete structural component, with the composite material, preferably the concrete. A concrete component is understood to include, among other things, a reinforced concrete component. In particular, the first handling unit is arranged and configured to produce a shotcrete component, preferably using a shotcrete process. Preferably, the first handling unit comprises a spray nozzle arranged to spray concrete. The first handling unit is further preferably configured such that the spray nozzle is movable in at least three spatial directions. In addition, the first handling unit preferably has supply lines for concrete and/or for compressed air and/or for one or more additives and/or control lines for controlling sensors and actuators.

The concrete to be processed in the second production module with the first handling unit is produced in the first production module in the mixing unit. To ensure that this produced concrete is available to the first handling unit, the first production module is coupled to the second production module by means of the conveyor unit. The conveyor unit is in particular a unit for conveying flowable materials. In particular, the conveyor unit is arranged and configured to move the composite material, in particular concrete, from the first manufacturing module to the second manufacturing module. The conveying unit may be, for example, a hose, a pipe and/or a concrete conveying component. Coupled together is to be understood in particular in such a way that the concrete can be moved, in particular conveyed, from the first manufacturing module to the second manufacturing module.

In a preferred embodiment of the production system, it is provided that the first production module and the second production module are formed separately from one another. The separate formation of the first manufacturing module and the second manufacturing module means in particular that they are not integrally formed. Furthermore, this may mean that the first manufacturing module and the second manufacturing module are each formed as a single unit. In particular, it is preferred that the first manufacturing module and the second manufacturing module are designed to be transportable and/or erectable separately from one another.

Various advantages are achieved by such a design of the first manufacturing module and the second manufacturing module. The different manufacturing modules can themselves be manufactured separately from one another. This results in advantages in the production process for manufacturing the first manufacturing module and the second manufacturing module, since only the interfaces have to be coordinated with each other.

In addition, the manufacturing modules can be provided as compact units that can be transported on a commercial truck, for example. Thus, the first manufacturing module and the second manufacturing module can be transported independently of each other and transported to a construction site, for example.

Furthermore, the set-up of the first manufacturing module relative to the second manufacturing module can be varied in a simple manner. This can be advantageous, for example, if the manufacturing system is used in a factory and there is a rearrangement of the manufacturing means, the individual manufacturing modules of the claimed manufacturing system can be easily moved, and, if necessary, only the conveyor unit acting as an interface is adapted. In addition to the conveyor unit, other elements can also act as an interface between the first manufacturing module and the second manufacturing module, for example control lines and compressed air lines.

In a further preferred embodiment of the manufacturing system, it is provided that the first manufacturing module has a supply unit for providing the first material component, preferably the first concrete component, and/or the second material component, preferably the second concrete component, preferably the supply unit having a first supply module for providing the first material component and a second supply module for providing the second material component.

The first supply module and/or the second supply module can or can be designed, for example, as a silo. The first supply module and/or the second supply module may or may not be fillable by, for example, a big bag, a crane system, a wheel bearing, and/or an industrial truck and/or a conveyor belt.

In addition, the first manufacturing module may include a conveyor device that conveys a material component, preferably a concrete component, located on the conveyor device to the mixing unit. For example, the first manufacturing module can have a receiving area for a concrete component, in particular an aggregate, in particular an opening. Through this opening, the concrete component can reach the supply unit and be conveyed to the mixing unit. Preferably, the supply unit is arranged vertically above the opening. The receiving area may, for example, be coupled to a silo for storing the concrete component, in particular to a screw conveyor system or a conveyor belt. Furthermore, the silo can also be coupled directly to the mixing unit via a screw conveyor system or a conveyor belt.

A further preferred further embodiment of the manufacturing system is characterized in that the first manufacturing module comprises a pump unit, wherein preferably a vibration unit is arranged between the mixing unit and the pump unit, and/or the pump unit comprises the or a vibration unit.

Preferably, the pump unit is arranged and configured such that it can be removed from the first manufacturing module. For example, the pump unit may be arranged on a rail unit arranged such that the pump unit is removable from the first manufacturing module.

Preferably, the vibration unit is arranged and configured to improve the flow of the produced concrete between the mixing unit and the pump unit and/or to improve the slippage of the concrete in a holding tank of the pump unit. In particular, the vibration unit is intended to prevent a concrete jam from occurring upstream of and/or in the pump unit and, if necessary, to block the path between the mixing unit and the pump unit and/or the path from the pump unit to the delivery unit. The vibration unit(s) may, for example, be electrically or pneumatically driven.

Furthermore, it is preferred that the manufacturing system comprises a fresh water storage unit, and it is particularly preferred that the fresh water storage unit is coupled to a water temperature control unit.

In a further preferred embodiment of the manufacturing system, it is provided that the first manufacturing module comprises a cleaning unit for automated cleaning, in particular of the mixing unit, the pump unit, an application unit, in particular the injection nozzle, of auxiliary units and/or hoses, wherein the cleaning unit preferably comprises a fluid pump for discharging a cleaning fluid and preferably the cleaning unit is configured to be fed with treated water and/or to treat water. The cleaning system, in particular the pump unit and/or the mixing unit, may or may not for example comprise cleaning fluid nozzles through which cleaning fluid may exit. In the event that there is substantially only concrete residue left in the mixing unit or the pump unit, these can be cleaned by means of cleaning fluid that emerges from the cleaning fluid nozzles.

It is preferred that the cleaning system has a cleaning controller that is set up to control the cleaning fluid nozzles with a predefined cleaning sequence. Furthermore, it may be preferred that the cleaning control is arranged to determine the predefined cleaning sequence, in particular based on output signals from sensors. The sensors are preferably configured to provide the output signals, wherein the output signals represent a degree of contamination in a sensor monitoring area. The manufacturing system may further comprise sensors for monitoring fill levels.

In a further preferred embodiment of the manufacturing system, it is provided that the first manufacturing module comprises a first metering unit and/or weighing unit, which is/are set up to adjust a component-specific mixing ratio between the first material component and the second material component. This embodiment has particular advantages, especially in combination with the second metering unit and weighing unit described in more detail below.

Systems known to date for the additive production of concrete components generally use a premixed material compound which is merely mixed with water and/or other admixtures at the production site so that a usable concrete is produced. However, this solution, which has been used up to now, has various disadvantages. Concrete components differ in terms of their geometry and size, so that different material properties are required for production. While, for example, the material for a column must set or harden very quickly so that a large height can be achieved in a short time, a material for a wide-area application, such as a wall, should set or harden more slowly because the travel times of the material-applying handling unit are longer. If a material solidifies too quickly, there is a high risk of a poor bond and thus a structurally installed predetermined breaking point between the successive layers of material.

As a result, a finished, premixed material compound is limited in the range of components that can be covered. In addition, this results in high material costs to transport the large quantities of material required to various destinations. By providing a supply unit, possibly with a first supply module and a second supply module and possibly further supply modules and corresponding metering units or weighing units, a concrete component mix that meets the requirements can be produced from different concrete components. This concrete component mixture can be mixed individually, in particular for each concrete component to be produced, so that the different material properties mentioned in the preceding are achieved in each case. This applies in an analogous manner to the provision of other composite materials comprising at least two material components.

A further preferred further development of the manufacturing system is characterized by the fact that the second manufacturing module has a second handling unit for carrying out support processes, in particular for reworking the composite material, for inserting reinforcing elements and/or for inserting component parts and/or for integrating components for securing component transport. These component parts can be, for example, slabs, paving blocks, brick slips, windows, doors and/or empty pipes. Components for transport can be, for example, transport anchors, threads for attaching anchors or equivalent solutions. In particular, the second handling unit may be arranged and configured to arrange a positioning element and/or a reinforcement unit. The finishing operation may in particular be or comprise a surface finishing operation.

It is further preferred that the first handling unit and the second handling unit cooperate such that they can perform a method comprising: Generating a first concrete layer and a second concrete layer with an additive method, preferably with a shotcrete method, in particular by the first handling unit, arranging a positioning element for arranging a reinforcement unit, wherein the positioning element is arranged with a supporting portion between the first concrete layer and the second concrete layer and cantilevers out from the first concrete layer and from the second concrete layer with an attachment portion, in particular with the second handling unit, arranging at least one reinforcement unit for reinforcing the concrete member on the positioning element, in particular with the second handling unit, and preferably producing a concrete covering layer on the first concrete layer and the second concrete layer in such a way that the reinforcement unit is substantially covered with concrete, in particular by the first handling unit.

The first handling unit may be designed as a first robot and/or the second handling unit may be designed as a second robot. The first robot and/or the second robot may or may not be designed, in particular, as an articulated-arm robot. It is particularly preferred that a distal end of the robot(s) is designed to be movable in three spatial directions. The first handling unit and/or or the second handling unit preferably each have an active area in which they can execute a manufacturing process, in particular a spraying process, preferably a shotcrete process, and/or a support process with a tool.

A further preferred further development of the manufacturing system is characterized in that the second manufacturing module comprises a turntable for rotating the component. For example, the rotary table may be located adjacent to the first handling unit and adjacent to the second handling unit. In particular, it is preferred that the rotary table is arranged between the first handling unit and the second handling unit. The rotary table integrates another axis into the manufacturing system, so that the geometric freedom is further increased.

Preferably, the turntable has a rotational axis that is oriented substantially vertically during operation. In addition, the rotary table may have one, two or more pivot axes such that the axis of rotation has a vertical component and a horizontal component. To further increase the flexibility of the manufacturing system, it may be preferred that the manufacturing system include a second, external rotary table. Preferably, the second rotary table is arranged adjacent to the second manufacturing module and is accessible by an external operator, for example by an industrial truck.

Furthermore, it is preferred that the second manufacturing module comprises a first tool changing system for changing tools used by the first handling unit and/or the second handling unit. It is preferred that the tool changing system is accessible from an external side of the manufacturing system for an operator to change and/or service the tools. Furthermore, it may be preferred that the second manufacturing module comprises a second tool changing system, preferably the first tool changing system being configured to exchange tools used by the first handling unit and/or the second tool changing system being configured to exchange tools used by the second handling unit.

In a further preferred embodiment of the manufacturing system, it is provided that the first handling unit and/or the second handling unit is/are arranged in a location-flexible manner. Locationally flexible means in particular that the first handling unit and/or the second handling unit can or can move relative to a base body of the second manufacturing module and in particular relative to a workpiece to be machined, in particular a component or concrete component.

In particular, it may be preferred that the first handling unit and/or the second handling unit is/are arranged on a linear axis. Preferably, the first handling unit and/or the second handling unit is/are coupled to a drive, preferably in each case, so that the first handling unit and/or the second handling unit is/are movable relative to the linear axis or axes.

Furthermore, it may be preferred that the first handling unit and/or the second handling unit has or have at least one multi-axis positioning system, wherein the multi-axis positioning system is set up such that the first handling unit and/or the second handling unit is or are movable in at least two spatial directions. The multi-axis positioning system can, for example, be designed as or comprise a lifting and rotating unit.

In a further preferred embodiment of the manufacturing system, it is provided that the second manufacturing module has at least two, preferably three, separate submodules, a first submodule having the first handling unit and/or a second submodule having the second handling unit and/or a third submodule having the rotary table, at least two of the submodules being designed to be transportable separately from one another. In particular, it is preferred that the third submodule can be arranged between the first and the second submodule. Furthermore, it is preferred that the second manufacturing module comprises a fourth sub-module, wherein the fourth sub-module comprises the second rotary table. The second sub-module is preferably arranged adjacent to the third sub-module, in particular such that a workpiece can be brought from the fourth sub-module to the third sub-module.

In a further preferred embodiment, it is provided that the manufacturing system comprises a component transport system arranged and configured to feed components to the first handling unit and/or the second handling unit. The component transport system can be set up, for example, to move pallets, in particular steel pallets, from an area outside the second manufacturing module into the second manufacturing module, so that a component arranged on a pallet can be moved in an active area of the first handling unit and/or the second handling unit. The component transport system can have, for example, a plurality of transport rollers which are arranged and designed to convey the pallets, in particular to convey them linearly.

The component transport system and the second manufacturing module are preferably arranged and configured such that pallets and/or components can be moved into the second manufacturing module on a first side of the second manufacturing module and can be moved out of the second manufacturing module again on the first side of the second manufacturing module. Alternatively or additionally, the component transport system and the second manufacturing module are preferably arranged and designed in such a way that pallets and/or components can be moved into the second manufacturing module on one or the first side of the second manufacturing module and can be moved out of the second manufacturing module on a second side of the second manufacturing module arranged opposite the first side.

In a further preferred embodiment, it is provided that the first sub-module, the second sub-module and/or the third sub-module is/are configured to vary a clear height of the interior space(s), in particular to increase it.

Preferably, the first sub-module, the second sub-module and/or the third sub-module has or have a lifting unit, in particular in each case, which is or are arranged and designed to increase the clear height of the interior space or spaces of the first sub-module, the second sub-module and/or the third sub-module, in particular by raising the roof or roofs and/or one or more side walls of the first sub-module, the second sub-module and/or the third sub-module.

Furthermore, it may be provided that at least one side wall of the sub-modules, preferably two side walls of the sub-modules are designed to be removable. For example, the third submodule can be arranged with the turntable between the first submodule and the second submodule. In order to be able to machine a concrete component arranged on the turntable, it is preferred that the side walls of the third sub-module facing the first sub-module and the second sub-module can be removed. Furthermore, it is preferred that the side walls of the first sub-module and the second sub-module facing the rotary table are designed to be removable.

In a further preferred embodiment of the manufacturing system, it is provided that the latter comprises a third manufacturing module having a feed unit for providing material components, which are in particular additives, preferably powdery, fibrous and/or liquid additives, and/or admixtures and/or binders, preferably the feed unit comprising a feed device and a conveying unit and/or a second metering unit.

The third manufacturing module may form a unit with the first manufacturing module. However, it is particularly preferred that the third manufacturing module is formed separately from the first manufacturing module, in particular that it can be transported and/or set up separately. The feeding device can be, for example, a silo, in particular a pneumatically fillable silo, a bag receiving station, also called a big bag station, or a bag feeding station. The binders can be, in particular, mineral and/or alkali-activatable binders and/or geopolymer-based binders. In particular, it is preferred that the third manufacturing module is provided for providing additives, admixtures and binders. In particular, it is then preferred that the first manufacturing module is essentially provided for providing aggregates.

A further preferred embodiment of the manufacturing system is characterized in that the third manufacturing module comprises a second weighing unit, which is set up to weigh and/or meter binders. Furthermore, the third manufacturing module may comprise a further weighing unit for weighing and/or dosing additives and/or admixtures. Furthermore, it may be preferred that the third manufacturing module comprises further metering units as well as further weighing units arranged to meter additives and admixtures. In a still further preferred embodiment, it is provided that the third production module comprises a coolant system for cooling the concrete. In particular, the coolant system for cooling the concrete may be a flake ice system for producing and/or providing ice for cooling the concrete. Furthermore, it is preferred that the coolant system is configured to provide ice to the pump unit. The ice may also be used to clean the pump unit.

A further preferred further embodiment of the manufacturing system is characterized in that the first manufacturing module, the second manufacturing module, the third manufacturing module and/or one, more or all of the sub-modules comprise a housing and/or are formed as a transport unit, for example a container, in particular a 10-foot and/or 20-foot and/or 40-foot container, wherein preferably side walls of the housings are at least partially openable. Furthermore, it is preferred that the side walls, floors and/or ceilings of the enclosure(s) comprise sound and/or heat insulating material. The sound and/or heat insulating material may be, for example, a mineral wool. The side walls, floors and/or ceilings may, for example, be provided with the mineral wool and be faced with a flow and/or a metal perforated sheet. Supplementally or alternatively, an insulating foam may be sprayed on and/or insulating mats may be arranged.

In a further preferred embodiment of the manufacturing system, it is provided that the roofs and/or side walls are designed to be liftable and are preferably coupled to a further lifting mechanism.

In a further preferred embodiment, it is provided that the first manufacturing module, the second manufacturing module, the third manufacturing module and/or one, more or all of the sub-modules comprises or comprise a first floor and a second floor spaced apart in the vertical direction for forming an intermediate space between the first floor and the second floor, wherein preferably a drain channel is arranged in the intermediate space for the disposal of cleaning fluid. The cleaning fluid may comprise, for example, fluid, in particular water, composite material, in particular concrete, and dirt particles.

In a further preferred embodiment, it is provided that the manufacturing system comprises a material separation device, in particular a concrete separation device, which is arranged to separate the composite material from a or the cleaning fluid. It is preferred that the material separation device acts in the drain channel. The material separation device has the advantage that composite material residues, in particular concrete residues, can be reused, thus increasing efficiency and environmental compatibility. For example, the material separation device may be arranged between the first floor and the second floor.

The first floor is preferably a working surface facing the concrete component in operation. The second floor is preferably arranged vertically below the first floor during operation. In the formed intermediate space between the first floor and the second floor, further devices of the manufacturing system may be arranged, for example also the conveyor unit, electrical lines and/or further supply devices.

According to a further aspect, the aforementioned task is solved by a method for the additive production of a component, preferably a concrete component, in particular using a spraying method, preferably a shotcrete method, comprising the steps of: providing a first material component, preferably a first concrete component, and a second material component, preferably a second concrete component, in particular at a supply unit of a manufacturing system, generating a composite material, preferably a concrete, by mixing the first material component, preferably the first concrete component, and the second material component, preferably the second concrete component, in particular in a mixing unit of the manufacturing system, and additively producing the component with the composite material, preferably the concrete component with the concrete, preferably by means of a spraying process, further preferably by means of a shotcrete process, in particular with a first handling unit.

In a preferred embodiment of the method, it is provided that the method comprises the step of: Metering the first material component, preferably the first concrete component, and the second material component, preferably the second concrete component, in a component-specific mixing ratio. It is further preferred that a third and/or further material components, in particular concrete components, are also metered so that a component-specific component mixture is produced.

It is further preferred that the method comprises the step of: Vibrating and/or pumping the composite material, preferably concrete, from the mixing unit towards the first handling system. It may be further preferred that the method comprises the step of: Reworking the component, preferably the concrete component, inserting a reinforcement element and/or inserting component components. The finishing of the structural component can be performed, for example, by means of smoothing and/or milling tools.

In a further preferred embodiment of the method, it is provided that it comprises the step of: Moving a workpiece and/or a pallet into an operative range of the first handling system and/or the second handling system. Preferably, the workpiece and/or the pallet is moved linearly into the effective area. Further preferably, the workpiece and/or the pallet is moved into the effective region on a first side of the effective region and is moved out of the effective region on a second side of the effective region arranged opposite the first side.

According to a further aspect, the aforementioned task is solved by a method for setting up a manufacturing system for additive production of components, preferably of concrete components, in particular for carrying out a spraying process, preferably a shotcrete process, for additive production of components, preferably of concrete components, comprising the steps: Providing a first manufacturing module with a mixing unit for generating a composite material, in particular a concrete, based on material components, preferably concrete components, in particular by mixing a first material component, preferably a first concrete component, and a second material component, preferably a second concrete component, providing a second manufacturing module with a first handling unit for additive production of a component with the composite material, preferably a concrete component with the concrete, in particular for production of a sprayed component, preferably a sprayed concrete component, and coupling the first manufacturing module and the second manufacturing module in such a way that the composite material produced in the mixing unit, preferably the concrete produced in the mixing unit, can be brought to the first handling unit.

In particular, the coupling of the first manufacturing module and the second manufacturing module is performed in such a way that a waste water generated during the manufacturing of the component can be discharged from the discharge channel. Furthermore, the coupling may be performed in such a way that control and/or compressed air lines are connected.

The processes and their possible further developments have features or process steps which make them particularly suitable for being used for a manufacturing system described in the foregoing and its further developments.

For further advantages, embodiment variants and embodiment details of the further aspects and their possible further embodiments, reference is also made to the previously given description concerning the corresponding features and further embodiments of the manufacturing system.

Preferred embodiments are explained by way of example with reference to the accompanying figures. They show:

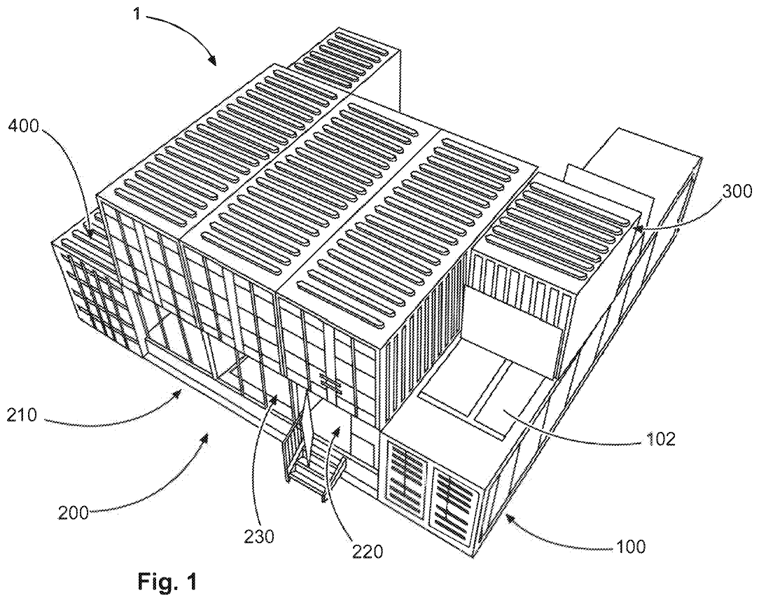

FIG. 1: a schematic, three-dimensional view of an exemplary embodiment of a manufacturing system;

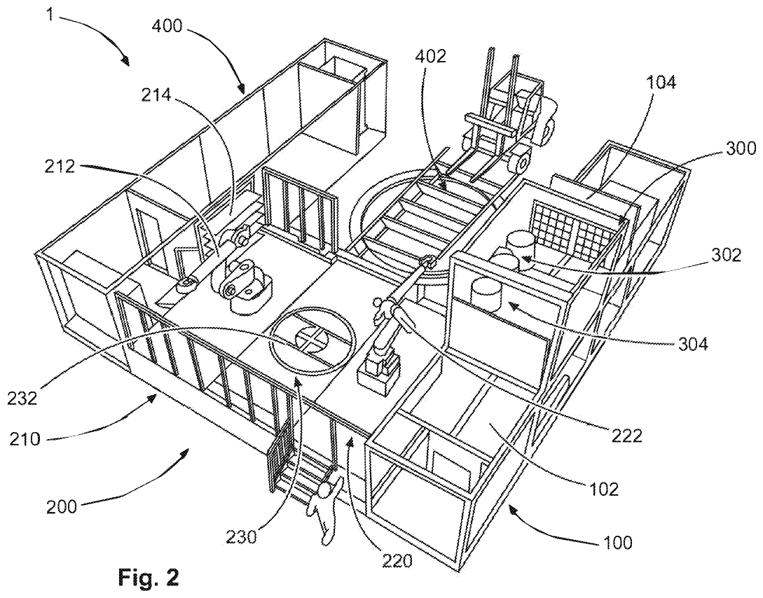

FIG. 2: a transparent view of the manufacturing system shown in FIG. 1;

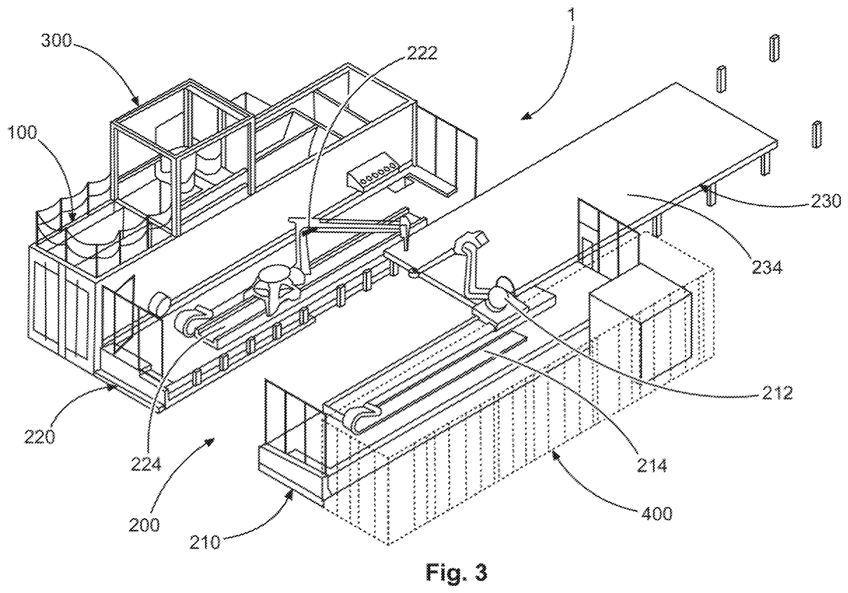

FIG. 3: another schematic, three-dimensional view of an exemplary embodiment of a manufacturing system;

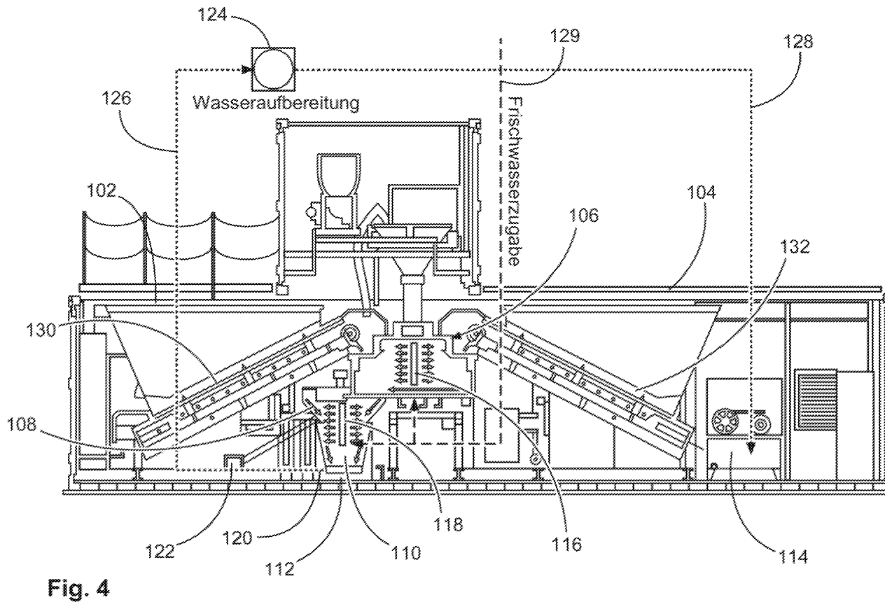

FIG. 4: a schematic, two-dimensional side view of the manufacturing system;

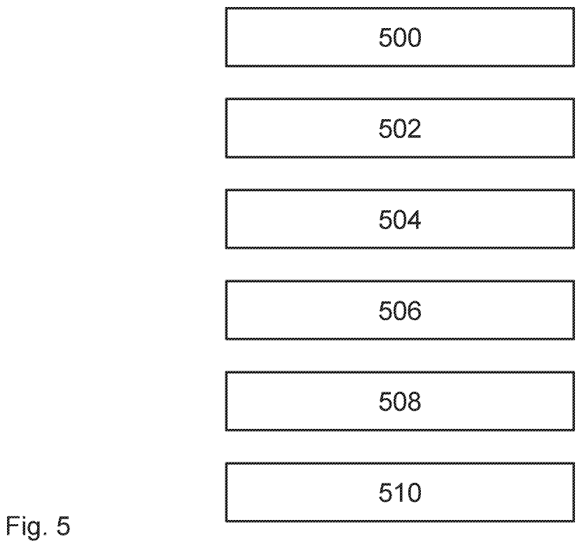

FIG. 5: a schematic representation of a process for the additive production of a concrete component; and

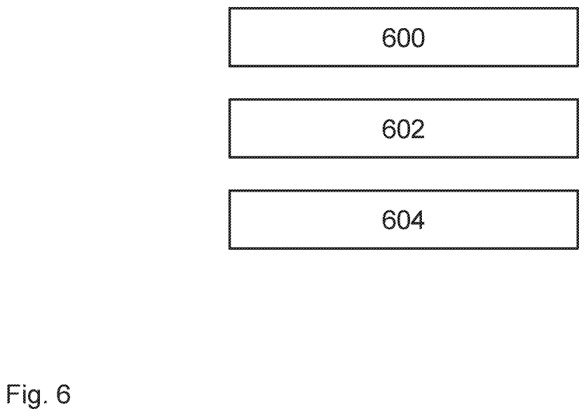

FIG. 6: a schematic view of a method for setting up a manufacturing system.

In the figures, identical or substantially functionally identical or similar elements are given the same reference signs.

FIG. 1 shows a manufacturing system 1 with a first manufacturing module 100, a second manufacturing module 200 and a third manufacturing module 300, whereby a peripheral module 400 is also provided. The first production module 100 has a first supply module 102 and a second supply module 104 shown in FIG. 2, through which a concrete component, in particular granules, can be introduced into the first production module 100. The second manufacturing module 200 includes a first sub-module 210, a second sub-module 220, and a third sub-module 230. The submodules 210, 220, 230 are configured to be vertically extendable. Each of the sub-modules 210, 220, 230 is a 20-foot container, and each includes a lifting system for raising the roofs and side walls of the sub-modules 210, 220, 230.

The interiors of the three modules 100, 200, 300 are shown in particular in FIG. 2. For manufacturing the concrete component with the concrete, the second manufacturing module 200 comprises a first handling unit 212. The first sub-module 210 further comprises a tool changing system 214 in which, for example, different spray nozzles for the handling unit 212 can be stored. Furthermore, the second manufacturing module 200 comprises a second handling unit 222, which is located in the second sub-module 220. The third sub-module 230, located between the first sub-module 210 and the second sub-module 220, includes a turntable 232. On the turntable 232, the concrete component is generated additively, in particular by means of a shotcrete process.

By means of the first supply module 102 and the second supply module 104, one or more concrete components can enter the first manufacturing module 100. Presently, these modules 102, 104 are formed as grids over which, for example, the concrete component can be dumped or can be provided, for example, in the form of a silo. From the supply modules 102, 104, the concrete component can reach a mixing unit.

Furthermore, the manufacturing system 1 comprises the third manufacturing module 300, which comprises feeding units 302 and a second metering unit 304. The charging units 302 are provided in particular for stocking additives, admixtures and binders for the concrete to be produced. The second metering unit 304, which is coupled to the charging units 302, can measure a weight or a volume or a quantity of the admixture or the binder and supply it to the underlying mixing unit 106 as required. In the mixing unit 106, these admixtures and binders are mixed with the concrete components, in particular granulates, supplied via the supply modules 102, 104.

The manufacturing system 1 further comprises a peripheral unit 400. The peripheral unit 400 comprises units for performing support processes. For example, the peripheral unit 400 may include an air pressure unit for providing compressed air. Furthermore, the peripheral unit 400 may comprise a wastewater treatment unit. Further, it may be preferred that the peripheral unit 400 comprises a power generator arranged and configured to provide electrical power to the manufacturing system. As a result, the manufacturing system can be operated autonomously and is particularly advantageously suitable for use close to the construction site. In addition, the peripheral unit 400 can comprise a reinforcement bending unit that is arranged and designed to form reinforcements, in particular reinforcing bars, in a component-specific manner.

FIG. 3 shows a further embodiment of the manufacturing system 1. In particular, the manufacturing system 1 differs from the manufacturing system described in the foregoing in that the first handling unit 212 and the second handling unit 222 are each arranged on a linear axis 214, 224. This arrangement allows the handling units 212, 222 to move in the direction of the linear axes 214, 224. As a result, the processing space is increased so that larger concrete components can be produced with the first handling unit 212. Furthermore, a linear table 234 is provided instead of the rotary table 232 described in the foregoing. The linear table 234 can be moved in the same direction as the handling units 212, 222. Thus, components can be moved into the manufacturing system 1 in a simple manner. In addition, even larger components can be manufactured by selective movement of the linear table 234.

FIG. 4 shows the interior of a first manufacturing module 100. A concrete component, in particular an aggregate granule, can pass through the supply modules 102, 104 onto the conveyor belts 130, 132. By means of the conveyor belts 130, 132, the concrete component is conveyed into the mixing unit 106. Vertically arranged above the mixing unit 106 is the third production module 300, which has the charging units 302. By means of the charging units 302 and the second metering unit 304, further concrete components, in particular binders and additives, are selectively brought into the mixing unit 106. In the mixing unit 106, the various concrete components are generally mixed together with water to produce a concrete. From the mixing unit 106, the concrete passes through a discharge hopper 108 towards a pumping unit 110. A conveyor unit 112 is arranged at the pumping unit 110, which couples the first manufacturing module 100 to the second manufacturing module 200.

Further, the first manufacturing module 100 includes a cleaning unit 114. The cleaning unit 114 is coupled to cleaning nozzles 116 in the mixing unit 106 and to cleaning nozzles 118 in the ejection hopper 108 and the pump unit 110. These are further coupled to a fresh water line 129. Fluid, in particular water, exiting the cleaning nozzles 116, 118 cleans the mixing unit 106, the ejection hopper 108 and the pump unit 110. In particular, when substantially no concrete to be processed is contained in these units, this cleaning is used. The water contaminated with cleaning particles, in particular concrete residues, is disposed of via a dirty water valve 120 and a dirty water pump 122. The disposal takes place via a gray water line 126, which passes a water treatment unit 124. From water treatment 124, the purified water returns to the purification system 114 via a white water line 128. From the purification system 114, the water can return to the purification cycle described previously.

FIG. 5 shows a method for additively producing a concrete component, in particular using a shotcrete process. In step 500, a first concrete component and/or a second concrete component is provided. This provision takes place in particular at a supply unit 102, 104 of a manufacturing system 1. This supply unit 102, 104 of the manufacturing system 1 can be formed, for example, by one, two or more silos or bag receiving devices.

In step 502, concrete is produced by mixing the first concrete component and the second concrete component. In particular, this mixing is performed in a mixing unit 106 of the manufacturing system 1. In step 504, a concrete component is additively manufactured using the previously generated concrete. This additive production of the concrete component is carried out in particular by means of a shotcrete process, in particular with a first handling unit 212.

Steps 500, 502, 504 may each comprise further steps, or further steps may take place between, before and/or after these steps, which will be described below.

In step 506, a first concrete component and a second concrete component are dispensed in a mix ratio specific to the component. In step 508, the concrete is then vibrated and/or pumped from the mixing unit to the handling system. In step 510, the concrete component is reworked, a reinforcement element is inserted and/or component components are inserted.

FIG. 6 shows a method for setting up a manufacturing system 1 for additive production of concrete components, in particular for carrying out a shotcrete process for additive production of concrete components. In step 600, a first manufacturing module 100 having a mixing unit 106 for generating a concrete based on concrete components is provided. In particular, the concrete is generated with the mixing unit by mixing a first concrete component and a second concrete component.

In step 602, a second manufacturing module 200 is provided with a first handling unit 212 for additive manufacturing a concrete component with the concrete. In particular, the first handling unit 212 is arranged and configured to produce a shotcrete component.

In step 604, the first manufacturing module 100 and the second manufacturing module 200 are coupled to each other, in particular such that the concrete generated in the mixing unit 106 is transferable to the first handling unit 212.

The manufacturing system 1 described in the foregoing has the particular advantage that it comprises a plurality of manufacturing modules 100, 200, 300, which are arranged in such a way that a modular structure of the manufacturing system 1 results in surprisingly high-quality components. This is made possible in particular by the clever selection of the distribution of the components provided in the manufacturing modules 100, 200, 300, in particular the mixing unit 106 and the handling units 212, 224.

In addition, the manufacturing system 1 enables on-site mixing of concrete component mixtures in that the manufacturing system 1 comprises the supply modules 102, 104 and the feeding units 302 with the second metering unit 304, so that a plurality of concrete components can be mixed together in a component-specific manner and thus no prefabricated concrete component mixtures are required.

The manufacturing system 1 further allows for flexible set-up in a manufacturing shop, on a construction site or in an area close to the construction site due to the setup with three separate manufacturing modules 100, 200, 300. The arrangement shown in the figures can be modified by adapting the interfaces so that the manufacturing system can be flexibly adapted.

### REFERENCE LIST

1 manufacturing system

100 first manufacturing module

102 first supply module

104 second supply module

106 mixing unit

108 ejector hopper

110 pump unit

112 conveying unit

114 cleaning unit

116 cleaning nozzles

118 cleaning nozzles

120 dirty water valve

122 dirty water pump

124 water treatment

126 gray water line

128 white water pipe

129 fresh water pipeline

130 first conveyor belt

132 second conveyor belt

200 second production module

210 first sub-module

212 first handling unit

214 tool changing system

214 first linear axis

220 second submodule

222 second handling unit

224 second linear axis

230 third submodule

232 rotary table

234 linear table

300 third manufacturing module

302 feeding units

304 second dosing unit

400 peripheral module

402 external rotary table

1. A manufacturing system for the additive production of concrete components, comprising
a first manufacturing module with a mixing unit configured to produce a composite concrete material by mixing a first concrete component and a second concrete component, and
a second manufacturing module comprising a first handling unit for additive production of a component with the composite concrete material,
wherein the first manufacturing module and the second manufacturing module are coupled by a conveyor unit.

2. The manufacturing system according to claim 1, wherein:
the first manufacturing module and the second manufacturing module are formed separately from one another, and
the first manufacturing module and the second manufacturing module being transportable and/or installable separately from one another.

3. The manufacturing system according to claim 1, wherein the first manufacturing module comprises a supply unit for providing the first concrete component and/or the second concrete component, wherein the supply unit comprises a first supply module for providing the first concrete component and a second supply module for providing the second concrete component.

4. The manufacturing system according to claim 1, wherein the first manufacturing module comprises:
a pump unit, wherein a vibration unit is arranged between the mixing unit and the pump unit, and/or the pump unit comprises the vibration unit, and/or
a cleaning system for automated cleaning of the mixing unit, of the pump unit, of an application unit and/or of auxiliary units, wherein the cleaning system comprises a fluid pump for discharging a cleaning fluid and the cleaning system is fed with treated water and/or to treat water.

5. The manufacturing system according to claim 1, wherein:
the first manufacturing module has a first metering unit and/or weighing unit, which is/are set up to set a component-specific mixing ratio between the first concrete component and the second concrete component.

6. The manufacturing system according to claim 1, wherein:
the second manufacturing module comprises a second handling unit for performing support processes, for finishing the composite concrete material, for inserting reinforcing elements, for inserting component parts and/or for integrating components for securing the transport of the component parts.

7. The manufacturing system according to claim 1, wherein the second manufacturing module comprises:
a rotary table for rotating the component, and/or
a first tool exchange system for exchanging tools used by the first handling unit and/or a second handling unit of the second manufacturing module.

8. The manufacturing system according to claim 1, wherein the first handling unit and/or a second handling unit of the second manufacturing module is/are arranged in a location-flexible manner, wherein the first handling unit and/or the second handling unit is/are arranged on a linear axis.

9. The manufacturing system according to claim 1, wherein the second manufacturing module comprises at least two separate submodules, wherein:
a first submodule comprises the first handling unit and/or
a second submodule comprises a second handling unit of the second manufacturing module and/or
a third submodule comprises the turntable,
wherein at least two of the submodules are designed to be transportable separately from each other.

10. The manufacturing system according to claim 1, comprising a third manufacturing module with a feeding unit for providing material components comprising additives, the additives comprising one or more of powdery, fibrous and/or liquid additives, and/or admixtures and/or binders, wherein the feeding unit comprises a feeding device and a conveying unit and/or a metering unit.

11. The manufacturing system according to claim 10, wherein the third manufacturing module comprises:
a second weighing unit arranged to weigh and/or meter binders, and/or comprises a further weighing unit arranged to weigh and/or meter additives and/or admixtures, and/or
further metering units, which are set up to meter admixtures and/or additives, and/or
a coolant unit comprising a flake ice unit for producing and/or providing ice for cooling the composite concrete material.

12. The manufacturing system according to claim 1 comprising a third manufacturing module, wherein the first manufacturing module, the second manufacturing module, the third manufacturing module and/or one, more or all of a plurality of submodules
have a housing and/or are configured as a transport unit, side walls of the housing being at least partially openable, an upper housing part being extendable and/or liftable, and/or
have side walls, floors and/or ceilings which have heat-insulating and/or sound-insulating material.

13. The manufacturing system according to claim 1 comprising a third manufacturing module, wherein:
the first manufacturing module, the second manufacturing module, the third manufacturing module and/or one, more or all of a plurality of sub-modules comprises a first floor and a second floor spaced in vertical direction for forming an intermediate space between the first floor and the second floor, a drain channel for disposal of cleaning fluid being arranged in the intermediate space.

14. A method for the additive production of a concrete component comprising the steps of:
providing a a first concrete component and a second concrete component at a supply unit of a manufacturing system,
generating a composite concrete material by mixing the first concrete component and the second concrete component in a mixing unit of the manufacturing system, and
additively producing the concrete component with the composite concrete material using a spraying process with a first handling unit.

15. The method according to the preceding claim 14, comprising the step or steps of:
metering the first concrete component and the second concrete component in a component-specific mixing ratio, and/or
vibrating and/or pumping the composite concrete material from the mixing unit to the first handling unit, and/or
finishing of the concrete component, including insertion of a reinforcement element and/or insertion of component parts and/or integration of components for component transport.

16. A method for setting up a manufacturing system for the additive production of concrete components, comprising the steps:
providing a first manufacturing module with a mixing unit for generating a composite concrete material by mixing a first concrete component and a second concrete component,
providing a second manufacturing module with a first handling unit for additively manufacturing a concrete component with the concrete, and
coupling the first manufacturing module and the second manufacturing module in such a way that the composite concrete material generated in the mixing unit can be brought to the first handling unit.

17. The manufacturing system according to claim 1, wherein the manufacturing system is configured to carry out a shotcrete process for the additive production of the concrete components.

18. The method according to claim 14, wherein additively producing the concrete component comprises additively producing the concrete component with the composite concrete material by using a shotcrete process.

19. The method according to claim 16, wherein the method comprises setting up the manufacturing system for the additive production of concrete components using a shotcrete process.
